(19) United States
(12) Patent Application Publication
(10) Pub. No.: US 2009/0313031 A1
(43) Pub. Date: Dec. 17, 2009

(54) Systems and Methods To sort Listings of Different Types

(76) Inventor: Jensen Lee, Sunland, CA (US)

Correspondence Address: AT&T Legal Department - GT;Attn: Patent Docketing, Room 2A-207, One AT&T Way, Bedminster, NJ, 07921, US

(21) Appl. No.: 12/137,357

(22) Filed: Jun. 11, 2008

(51) Int. Cl. G06Q 30/00; G06F 17/30; G06F 7/08; G06F 7/10

(52) U.S. Cl. 705/1; 707/7; 707/3; 707/5; 707/E17.014; 707/E17.005

(57) ABSTRACT

Systems and methods are provided to facilitate the presentation of listings of different types as an ordered list. For example, subscription listings and pay for performance listings can be sorted into a mixed list to balance the protection of subscriptions for stable and long term revenue, and the presentation of pay for performance listings that can increase short term revenue.

### FIELD OF THE TECHNOLOGY

At least some embodiments disclosed herein relate to search and presentation of information in general and, particularly but not limited to, searching for information related to businesses of services or products.

### BACKGROUND

An end user may be interested in information about business entities near a particular location, such as service providers of a particular category near the current location of the end user, or a different location specified by the end user.

Thus, some websites allow an end user to search for providers of services and/or products by entering one or more keywords and a location of interest. After a keyword search, the website may sort and present the search results to the end user. Alternatively, a website may organize the categories of businesses according to a predetermined hierarchy to allow a user to browse categories of providers of services and/or products.

For example, an online website may present business listings of various services and/or products based on locations and user entered search terms, or based on selections from a predetermined set of categories.

For presentation purposes, a website may sort the search results based on the distance between the location of interest to the end user and the locations of the business entities, or based on a different criterion, such as price, advertisement fee, user ratings, etc.

### BRIEF DESCRIPTION OF THE DRAWINGS

The embodiments are illustrated by way of example and not limitation in the figures of the accompanying drawings in which like references indicate similar elements.

FIG. 1 shows a system to search, sort and/or present listings according to one embodiment.

FIG. 2 illustrates an example to sort subscription listings and pay for performance listings according to one embodiment.

FIG. 3 illustrates a method to generate a mixed list of listings of different types according to one embodiment.

FIG. 4 illustrates another method to generate a mixed list of listings of different types according to one embodiment.

FIG. 5 shows a flow diagram example of a method to present listings of different types according to one embodiment.

FIG. 6 illustrates a data processing system which can be used in various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present disclosure provides systems and methods to facilitate the presentation of listings of different types as an ordered list. For example, subscription listings and pay for performance listings can be sorted into a mixed list to balance the protection of subscriptions for stable and long term revenue, and the presentation of pay for performance listings that can increase short term revenue. The disclosure includes methods and apparatuses which perform these methods, including data processing systems which perform these methods, and computer readable media containing instructions which when executed on data processing systems cause the systems to perform these methods.

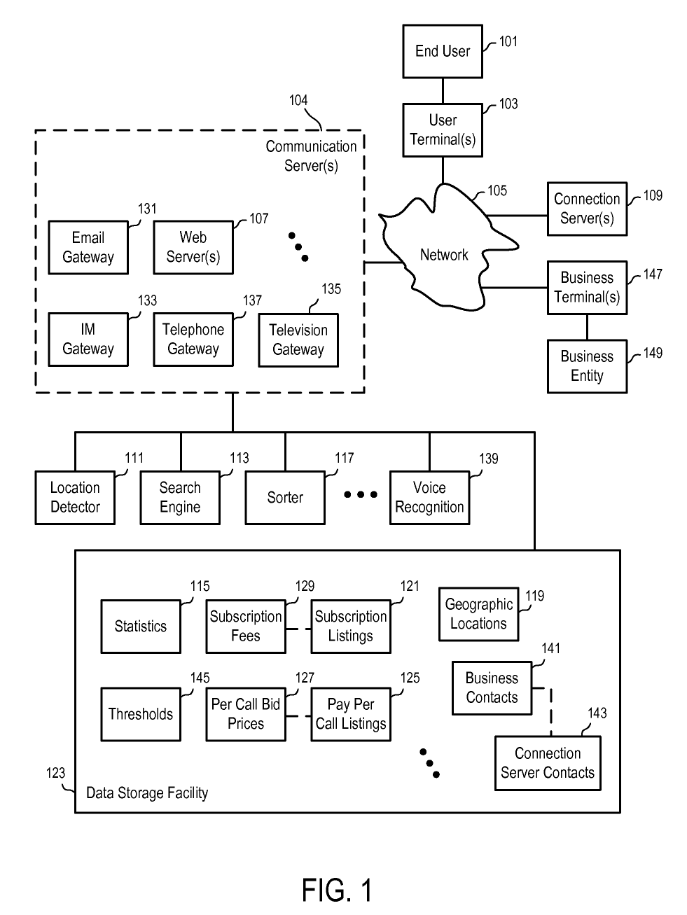

FIG. 1 shows a system to search, sort and/or present listings according to one embodiment.

In FIG. 1, an end user (101) uses a user terminal (103) to submit a search request over the network (105) to a communication server (104) and/or to receive search results. The network (105) may include a local area network, a wireless data communication network, a telephone network, a cellular communication network, a telecommunication network, an interactive television network, an Internet Protocol Television (IPTV) network, an intranet, or a combination of networks, such as Internet.

A communication server (104) may include a web server (107), an email gateway (131), an instant messaging (IM) gateway (133), a telephone gateway (137), a television gateway (135), and/or other types of servers, such as an application gateway (not shown) to interface different servers. Some embodiments may use one type of communication server (104), such as a web server (107), to receive the search request and another type of communication server (104), such as a television gateway (135), to provide the search results. Some embodiments may use different types of communication servers (104) to service different types of user terminals (103).

In one embodiment, the web server (107) communicates with the user terminal (103) via HyperText Transfer Protocol (HTTP) and/or other types of communication protocols, such as File Transfer Protocol (FTP), Wireless Application Protocol (WAP), etc. The web server (107) may provide static web pages, dynamic web pages, and/or web services. In some embodiments, the web server (107) provides web applications to the user terminal (103) for execution in a web browser running on the user terminal (103); and the web applications may include scripts, such as Java, JavaScript, etc., for execution within an isolated environment in a browser. In some embodiments, the web server (107) may provide rich-client applications to the user terminal (103); and the rich-client application may be programmed in traditional programming languages, such as C/C++, to have full access to functions of the operating system running on the user terminal (103).

The communications server(s) (104) communicates with a location detector (111), a search engine (113), and/or a sorter (117) to process the search request and present search results based on the information stored in a data storage facility (123).

In some embodiments, the location detector (111), the search engine (113), the sorter (117) and/or other modules, such as the voice recognition system (112), are servers communicating with the communication server (104) over a network, such as a local area network, an intranet, or Internet. These servers and the communication servers (104) may run on same or separate computers. In one embodiment, there may be one or more layers of application servers between the communication server (104) and the data storage facility (123) to process the business logic and data access of the rich client applications. Alternatively, application servers may be integrated with the communication servers (104), such as the web servers (107). Thus, the disclosure is not limited to particular types of connections among the communication servers (104), the location detector (111), the search engine (113), the sorter (117), the data storage facility (123) and other modules, such as the voice recognition system (112).

Listings (e.g., 121 and 125) of businesses or people, such as restaurants, car dealers, retailer locations, service providers, gas stations, parking lots, plumbers, and the like, may have street addresses or other location parameters, such as longitude and latitude coordinates, stored as locations (119) in the data storage facility (123). The listings (e.g., 121 and 125) may include addresses, telephone numbers, advertisements, announcements, and/or events, etc. The locations (119) may be part of the listings (e.g., 121 and 125), or associated with the listings (e.g., 121 and 125). In one embodiment, the listings (e.g., 121 and 125) are information related to business entities (149) at corresponding geographic locations (119). The entities (149) may be businesses or people. Some of the entities (149) may be advertisers who pay advertisement fees to promote their listings (e.g., 121 and 125). Some of the entities (149) may be non-advertisers who have free listings (not shown in FIG. 1).

In one embodiment, the business entities (149) may promote their listings (e.g., 121 and 125) in different ways. For example, some business entities (149) may pay subscription fees (129) to promote listings (121) on a subscription basis; and some business entities (149) may offer per call bid prices (127) to promote listings (125) on a pay per call basis, in which a business entity (149) pays an advertisement fee according to the per call bid price (127) in response to a telephone call to the terminal (147) of the business entity (149) as a result of the presentation of the pay per call listing (125).

FIG. 1 presents pay per call listings (125) as an example of pay for performance listings. Alternatively, or in combination, the data storage facility (123) may also store other types of pay for performance listings, in which the business entity (149) pays an advertisement fee in response to certain actions from the end user (101) as a result of the presentation of the pay for performance listings.

Examples of other types of pay for performance listings include pay per click listings, earn per call listings, etc. A pay per click listing may include a link to a website of the business entity (149). The business entity (149) pays an advertisement fee in response to the end user (101) selecting or clicking the link in the listing to visit the website of the business entity (149).

An earn per call listing may include a telephonic contact of the business entity (149) which provides services over telephonic connections between the terminal (103) of the end user (101) and the terminal (147) of the business entity (149). The end user (101) pays the business entity (149) for the services of the business entity (149); and the business entity (149) pays an advertisement fee, or a commission fee, using a portion of what the end user (101) pays for the services of the business entity (149), when the end user (101) purchases the services of the business entity (149) as a result of the presentation of the earn per call listing.

In one embodiment, a pay per call listing (125) (or an earn per call listing) includes a contact (143) of the connection server (109), which is used to represent the contact (141) of the business entity (149). When the end user (101) uses the connection server contact (143) to establish a telephonic connection between the user terminal (103) and the connection server (109), the connection server (109) identifies the business contact (141) based on the association between the connection server contact (143) and the business contact (141) and thus further connects the end user (101) to the terminal (147) of the business entity (149). For example, the connection server (109) may further connect the end user (101) to the business entity (149) by forwarding the call, or by making a separate telephonic connection between the connection server (109) and the terminal (147) of the business entity (149) and bridging or conferencing the telephonic connections to connect the terminal (103) of the end user (101) and the terminal (147) of the business entity (149).

In one embodiment, in response to the connection server (109) connecting the telephone call to the terminal (147) of the business entity (149), the connection server (109) charges the business entity (149) according to the per call bid price (127) of the pay per call listing (125).

In one embodiment, the business entity (149) can specify a per call bid price (127) for the pay per call listing (125). The business entity may specify a budget for a period of time, such as a day, a week, or a month. Before the accumulative advertisement fees reach the budget, the business entity (149) pays an advertisement fee according to the per call bid price (127) in response to calls to the business contact (141) through the pay per call listing (125). After the accumulative advertisement fees reach the budget, the pay per call listing (125) may become as a free listing.

In one embodiment, the business entity (149) can select a subscription level for a subscription listing (121). Different levels of subscription, such as platinum level, gold level, silver level, bronze level, etc., may require different amounts of subscription fees. Further, within a subscription level, the business entity (149) may purchase different subscription options, such as banner advertisements, video advertisements, links to websites, etc. At the end of a subscription period, the business entity (149) may decide whether or not to pay the subscription fees (129) to renew the subscription for the listing (121). The business entity (149) may upgrade or downgrade subscription levels and options. When the business entity (149) does not renew the subscription, the subscription listing (121) may become a free listing. Alternatively, the business entity (149) may choose to stop paying the subscription fee (129) but offer a per call bid price (127) to convert a subscription listing (121) into a pay per call listing (125).

In one embodiment, the search engine (113) and the sorter (117) promote the listings (e.g., 121 and 125) in search results based on the value of the listings (e.g., 121 and 125). In one embodiment, after the search engine (113) identifies different types of listings according to a search request from the end user (101), the sorter (117) sorts the identified listings into a mixed list, which may included the subscription listings (121) and the pay per call listings (125). The sorter (117) may also sort different types of listings (e.g., 121 and 125) in response to the end user (101) browsing predetermined categories.

In one embodiment, the sorter (117) provides the mixed list in an order to increase revenue or yield over a period of time, such as over a period of time longer than a subscription period. To increase revenue for such a period of time, the sorter (117) balances the promotion of subscription listings (121) and the promotion of pay for performance listings, such as pay per call listings (125), to prevent subscription cannibalization and to increase revenue opportunities.

For example, when the sorter (117) gives the subscription listings (121) higher priority than pay per call listings (125), the pay per call listings (125) may not have sufficient exposure in the search results, which might limit the revenue opportunities from the pay per call listings (125). When the sorter (117) gives the pay per call listings (125) higher priority than subscription listings (121), the subscription listings (125) may not have sufficient exposure in the search results, which, although possibly leading to short term increase in revenue, might cause dissatisfaction in subscription services and thus lead to downgrade or non-renewal of subscriptions.

In one embodiment, the sorter (117) balances the priority of subscription listings (121) and the priority of pay for performance listings, such as pay per call listings (125), using thresholds (145). In one embodiment, the sorter (117) or another module not shown in FIG. 1 determines the thresholds (145) based on statistics (115) about the performances of the listings (e.g., 121 and 125).

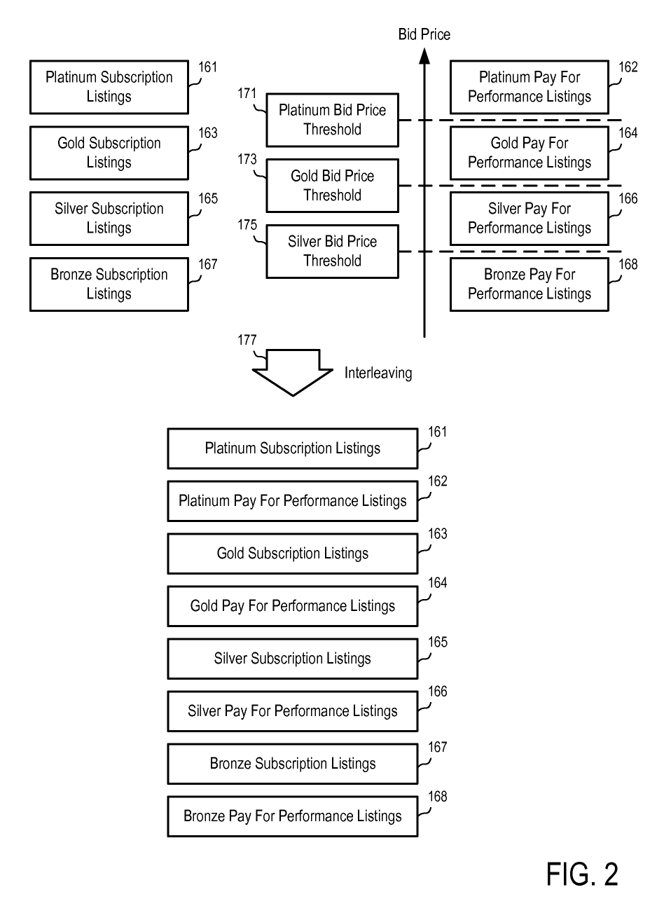

In one embodiment, the sorter (117) uses thresholds (145) to divide the pay per call listings (125) according to their per call bid prices (127) into different levels corresponding to the subscription levels of the subscription listings (121). The sorter (117) groups the different types of listings according to level to interleave the different types of listings, such as the subscription listings (121) and pay per call listings (125), as illustrated in FIG. 2.

FIG. 2 illustrates an example to sort subscription listings and pay for performance listings according to one embodiment. In FIG. 2, the sorter (117) divides the subscription listings (121) in a search result into groups (161, 163, 165, and 167) based on their subscription levels. In one embodiment, different subscription levels correspond to different subscription fees (129).

In one embodiment, within each group (e.g., 161, 163, 165, or 167) of the subscription listings (121), the sorter (117) sorts the listings (121) based on the fees for subscription options and/or other criteria, such as a distance to a location of interest to the end user (101), user ratings, etc.

In FIG. 2, the sorter (117) sorts the pay for performance listings, such as pay per call listings (125), according to bid price, such as per call bid prices (145). The sorter (117) uses the thresholds (171, 173, and 175) to divide the sorted pay for performance listings into groups (162, 164, 166, and 168), which corresponding to groups (161, 163, 165, and 167) of subscription listings (121). The sorter (117) generates a combined list by interleaving (177) the groups (161-168) of listings (e.g., 121 and 125). As illustrated FIG. 2, the sorter (117) interleaves (177) the listings (e.g., 121 and 125) in unit of groups.

In one embodiment, for listings (e.g., 121 and 125) of the same group level, the sorter (117) provides subscription listings (121) with higher priority than pay for performance listings, such as pay per call listings (125). For example, in FIG. 2, the group (162) of platinum pay for performance listings are at the same group level as the group (161) of platinum subscription listings (121); and the sorter (117) places the group (161) of platinum subscription listings (121) above the group (162) of platinum pay for performance listings in the combined list.

In FIG. 2, according to the group levels, groups (163 and 164) of gold listings, groups (165 and 166) of silver listings, and groups (167 and 168) of bronze listings are placed below the groups (161 and 162) of platinum listings.

In one embodiment, the sorter (117) or another module not shown in FIG. 1 determines the thresholds (171, 173 and 175) according to statistic data (115), such that an average listing in a group (e.g., 162) of pay for performance listings can generate revenue comparable to the subscription fees (129) of the corresponding group (e.g., 161) of subscription listings (121).

For example, the statistic data (115) may include the number of calls connected via the group (161) of subscription listings (121); and the sorter (117) or another module not shown in FIG. 1 may determine the threshold (171) based on dividing the subscription fees (129) of the group (161) of subscription listings (121) by the number of calls connected via the group (161) of subscription listings (121) during a subscription period.

In one embodiment, the sorter (117) or another module not shown in FIG. 1 may determine the threshold (171) based on the category to which the listings (e.g., 121, and 125) in the search result belong. For example, to compute the threshold (171) for platinum level, the sorter (117) uses not only the statistic data (115) from the group (161) of platinum subscription listings in the search result, but also the statistic data (115) from other platinum subscription listings that are at the same platinum subscription level and in the same listing category as the search result. In some embodiments, the sorter (117) pre-determines the threshold (171) for the subscription level and the listing category prior to the search request and updates the threshold (171) periodically. Alternatively, the sorter (117) may dynamically determine the threshold (171) in response to the search request.

In one embodiment, an administrator estimates the thresholds (171, 173, and 175) for the sorter (117). The sorter (117) uses the estimated thresholds (171, 173, and 175) for an initial period of time, during which the communication servers (104) and/or the connection server (109) can collect the statistics (115), and then use statistics (115) to compute the thresholds (171, 173, and 175).

In one embodiment, to determine the thresholds (145), the communication server (104) and/or the connection server (109) may track the performance of not only the pay for performance listings, such as the pay per call listings (125), but also the subscription listings (121). The average performance levels of the subscription listings of a subscription level determine the threshold (145).

Alternatively, the performance of the pay for performance listings, such as pay per call listings (125), can be used to estimate the performance of the subscription listings. For example, assuming that the call through rate of the subscription listings (121) is comparable to the call through rate of the pay per call listings (125) of the same listing category, the number of calls connected via the subscription listings (121) can be estimated by dividing the number of presentations of the subscription listings (121) by the call through rate of the pay per call listings (125) in the same listing category.

Different listings may have different conversion rates between presentation and performance, because of brand recognition, service or product quality, market conditions, etc. Using the conversion rate the sorter (117) or another module not shown in FIG. 1 may estimate the expected revenue for presenting a pay for performance listing, such as a pay per call listing. For example, when a pay per call listing has a conversion rate of 50% and a bid price of $5.00 per call, the expected revenue for presenting the listing is $2.50.

In one embodiment, the sorter (117) or another module not shown in FIG. 1 may estimate the expected revenue for presenting the pay for performance listings based on statistics (115) of the pay for performance listings, such as the pay per call listings (125), and sort the pay for performance listings according to the expected revenue. Based on the statistics of the subscription listings (123), the sorter (117) or another module not shown in FIG. 1 may determine the average received revenue for different levels of subscription listings (123). The average received revenue can be used to determine the thresholds (145) by which to divide the pay for performance listings according to the expected revenue.

In a further embodiment, the sorter (117) or another module not shown in FIG. 1 may compute the average received revenue for each presentation of a subscription listing (121), based on the statistics of the previous subscription period, or based on the projection in the current subscription period. The sorter (117) compares the average received revenue per presentation of subscription listings (121) to the expected revenue per presentation of pay for performance listings to sort the subscription listings (121) and the pay for performance listings, such as the pay per call listings (125), into a mixed list.

In one embodiment, in response to a search request from the end user (101) which has an indication of a location of interest, the search engine (113) identifies listings (e.g., 121 and 125) in a local area near the location of interest. When a pay for performance listing not only satisfies the search request but also provides services or products in more than a predetermined number of states, the sorter (117) may place this pay for performance listing in the group (162) for platinum pay for performance listings, even if the bid price of this listing is lower than the platinum threshold (171).

In one embodiment, a listing is a nationwide listing when the listing provides services or products in more than a predetermined number of states. To promote nationwide pay for performance listings, after the search engine (113) or the sorter (117) selects up to a predetermined number of nationwide pay for performance listings that satisfy the search request from the end user, the sorter (117) includes the selected nationwide pay for performance listings, such as nationwide pay per call listings (125), in the platinum level of listings, even if the bid prices of the selected nationwide pay for performance listings are lower than the platinum threshold (171).

In one embodiment, the location detector (111) determines a location of interest to the end user (101) related to the search request. The end user (101) may explicitly specify the location of interest in the search request; and the location detector (111) extracts the location of interest from the search request.

Alternatively, the end user (101) may implicitly specify the location of interest based on a preference stored and associated with identification information of the end user (101) or the user terminal (103).

In some embodiments, the location detector (111) automatically identifies the location of interest based on determining the current location of the user terminal (103) that is used to submit the search request. For example, the location detector (111) may determine the location of the user terminal (103) based on a connection point the user terminal (103) used to access the network (105) (e.g., based on the location of a wireless network access point, a base station of a cellular communication system, or a connection point to a wired network). In some embodiments, the user terminal (103) automatically determines its current position (e.g., via a satellite positioning system, or a cellular positioning system) and transmits the determined or estimated position to the web server (107) with the search request, or provides the position in response to a request from the location detector (111).

In one embodiment, the terminal (103) of the end user (101), or the terminal (147) of the business entity (149), is a data processing system, such as a notebook computer, a personal computer, a workstation, a network computer, a personal digital assistant (PDA), a mobile phone, a cellular phone, a landline phone, a television set with or without a set top box, a game console, an electronic kiosk, microprocessor-based or programmable consumer electronics, and the like.

In one embodiment, the user terminal (103) includes a web browser which allows the end user (101) to submit a search request to one of the web servers (107) for location dependent information, such as a listing (121) of businesses or people, such as restaurants, car dealers, retailer locations, service providers, gas stations, parking lots, plumbers, and the like. Alternatively, the user terminal (103) may provide the search request via other communication channels, such as email, short message service (SMS), instant messaging (IM), telephone connection, etc. For example, the user terminal (103) may provide the search request to an email gateway (131a) via email, or to an IM gateway (133) via instant messaging, or to a telephone gateway (137) via a telephone call, or to a television gateway (135) via an interactive television system. Some embodiments may use other types of gateways not shown in FIG. 1, such as gateways for SMS. Thus, the disclosure is not limited to the examples or combinations illustrated in FIG. 1.

In one embodiment, after the end user (101) uses one user terminal (103) to receive a listing (e.g., 121, or 125) which includes a contact (143) of the connection server (109), the end user (101) may use the same user terminal (103), or a different user terminal (103), to request a connection via the contact (143) of the connection server (109). The connection server (109) determines the contact (141) of the business entity (149) to further connect the user terminal (103) to the terminal (147) of the business entity (149). Such connections may be telephonic connections, or other types of connections for real time communications, such as connections for instant messaging, connections for text, voice and/or video chatting, connections for application sharing, screen sharing, document sharing, common whiteboarding, etc. In one embodiment, the establishment of such connections is an event used to measure the performance of pay for performance listings, such as pay per call listings (125). In one embodiment, the connection server (109) monitors such connections to charge the end user (101) on behalf of the business entity (149) for services delivered over such connections.

In some embodiments, the end user (101) may use one user terminal (103) to submit the search request and another user terminal (103) to receive the search results. For example, the user (101) may submit the search request via an SMS message through one user terminal (103), and receive the search results at another user terminal (103) via email. For example, the user may submit the search request via voice through one user terminal (103) and receive the search results via a web page at another user terminal (103) or at the same user terminal (103). For example, in one embodiment, the user (101) may use a mobile phone as the user terminal (103) to transmit voice information, via a data connection through the network (105) and the web server (107) (or email gateway (131), or IM gateway (133), or other data communication gateways), or a telephone connection through a telephone gateway (137), to a voice recognition system (112) to formulate a search and receive a web page or email at the same user terminal (103) or at another user terminal (103) that shows the results of the search.

In one embodiment, one computer system implements the web servers (107), the location detector (111), the search engine (113), and the sorter (117). Alternatively, different processes running on one or more shared computers may implement some of the components (107, 111, 113, and 117). For example, one computing module, thread, or process may implement multiple of the components (107, 111, 113, and 117). In some embodiments, special purpose data processing systems implement the one or more of the components (107, 111, 113, and 117), such as using Application-Specific Integrated Circuit (ASIC) or Field-Programmable Gate Array (FPGA). In some embodiments, processes running according to software instructions on general purpose data processing systems, such as general purpose personal computers or server computers, can implement the components (107, 111, 113, and 117). Thus, the implementations are not limited to hardware, software, or particular combinations of hardware and software.

Different embodiments may implement the data storage facility (123) in different ways. For example, one or more data processing systems may store the information about the statistics (115), thresholds (145), subscription listings (121) and their subscription fees (129), pay per call listings (125) and their per call bid prices (127), the geographic locations (119) of the listings (e.g., 121, 125), the contacts (141) of the business entities (149) corresponding to the listings (e.g., 121, 125), and/or the contacts (143) of the connection server (109) which are used by the connection server (109) to receive connections from the terminals (103) of the end user (101) for a connection to the terminal (147) of the business entity (149) corresponding to a listing (e.g., 125). For example, the data storage facility (124) may include one or more relational or object oriented databases, or flat files on one or more computers or networked storage devices, etc. The data storage facility (124) may be a centralized system, or include a distributed system, such as a peer to peer network, or Internet.

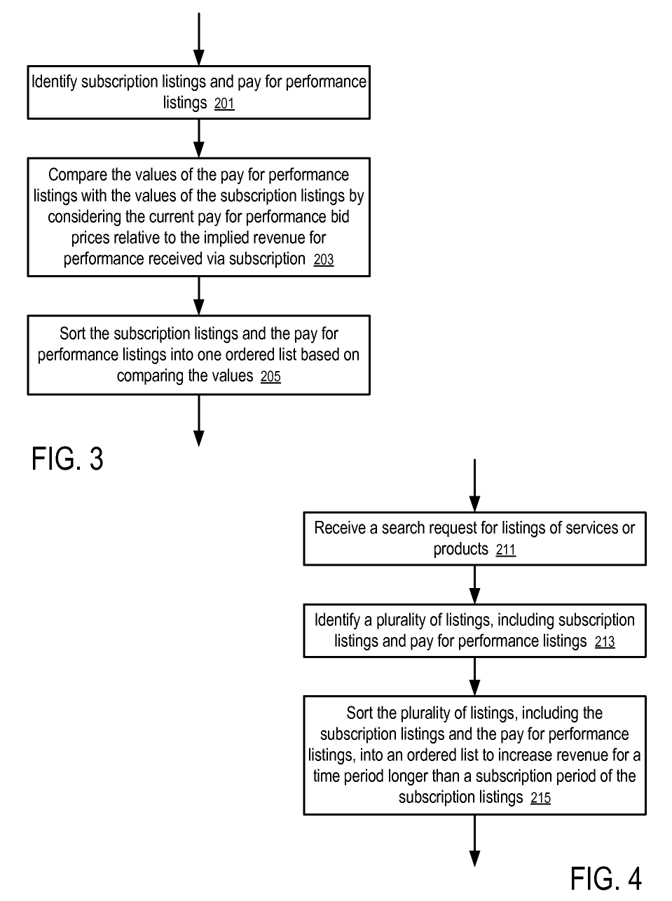

FIG. 3 illustrates a method to generate a mixed list of listings of different types according to one embodiment.

In FIG. 3, a search engine (113) identifies (201) subscription listings (121) and pay for performance listings, such as pay per call listings (125), pay per click listings, pay per video view listings, and/or earn per call listings, etc. A sorter (117) compares (203) the values of the pay for performance listings, such as the pay per call listings (125), with the values of the subscription listings (203) by considering the current pay for performance bid prices relative to the implied revenue for performance received via subscription, such as implied revenue per call received by businesses via their subscription listings. In one embodiment, the sorter (117) determines the implied revenue per call based on the subscription fees of the subscription listings and calls received by the businesses via the subscription listings in current and/or past subscription periods. Thus, the value comparison not only includes the consideration of the short term revenue that may come from the pay for performance listings but also includes the consideration of future revenue that may come from the future renewal of subscriptions. The sorter (117) sorts (205) the subscription listings (121) and the pay for performance listings, such as the pay per call listings (125), into one ordered list based on comparing the values.

In one embodiment, the sorter (117) further appends free listings after the ordered list. In one embodiment, the subscription listings (121), the pay for performance listings (e.g., pay per call listings (125)), and the free listings provide telephonic contact of businesses of services or products. The technologies disclosed herein can be used, for example, in a website such as YELLOWPAGES.COM.

In one embodiment, the values of the pay for performance listings (e.g., pay per call listings (125)) are based at least in part on the bid prices (e.g., per call bid prices (127)) and a conversion rate between presentation and performance.

FIG. 4 illustrates another method to generate a mixed list of listings of different types according to one embodiment.

In FIG. 4, after a communication server (104) receives (211) a search request for listings of services or products, a search engine (113) identifies (213) a plurality of listings, including subscription listings (121) and pay for performance listings (213), such as pay per call listings (125). A sorter (117) sorts (215) the plurality of listings, including the subscription listings (121) and the pay for performance listings (e.g., pay per call listings (125)), into an ordered list to increase revenue for a time period longer than a subscription period of the subscription listings (121).

In one embodiment, the subscription listings (121) offer periodic subscription fees (129) for priority in search results; and the pay for performance listings offer fees to be charged in response to a predetermined event that is a result of presentation of the pay for performance listings. For example, the pay for performance listings may include pay per call listings (125), for which the predetermined event is connecting a telephone call to a telephonic contact of the business entity (149).

In one embodiment, the connection server (109) tracks telephone calls to telephonic contacts associated with the subscription listings (121); based on the tracked telephone calls, the sorter (117) converts the subscription fees to equivalent fees charged in response to a telephone call to sort the different types of listings (121 and 125).

In one embodiment, the equivalent fees are based on business categories of the subscription listings and subscription levels of the subscription listings.

In one embodiment, the search request indicates a geographic area. The search engine (113) or the sorter (117) identifies no more than a predetermined number of first pay for performance listings for inclusion in the plurality of listings, where the first pay for performance listings provide services or products in the geographic area and in more than a predetermined number of states. The search engine (113) or the sorter (117) identifies second pay for performance listings for inclusion in the plurality of listings, where the second pay for performance listings provides services or products in the geographic area and in no more than the predetermined number of states. The sorter (117) provides the first pay for performance listings with priority higher than the second pay for performance listings in the ordered list.

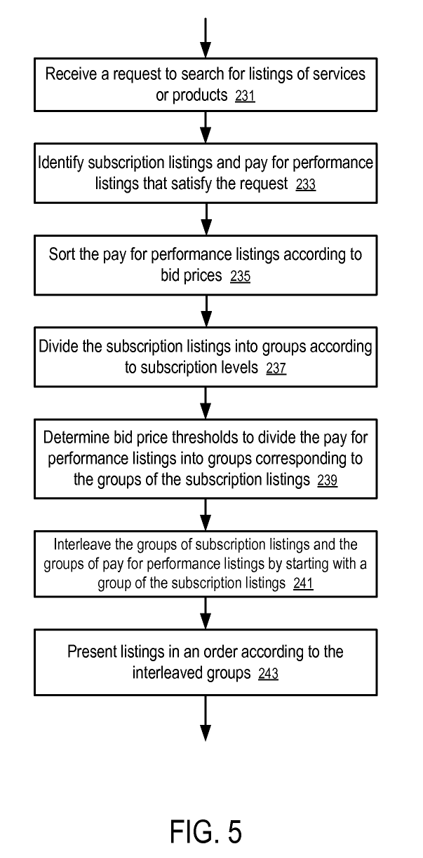

FIG. 5 shows a flow diagram example of a method to present listings of different types according to one embodiment.

In FIG. 5, responsive to a communication server (104) receiving (231) a request to search for listings of services or products (231), a search engine (113) identifies (233) subscription listings (121) and pay for performance listings, such as pay per call listings (125), that satisfy the request.

A sorter (117) sorts the pay for performance listings (e.g., pay per call listings (125)) according to bid prices (235), divides (237) the subscription listings (121) into groups (e.g., 161, 163, 165, and 167) according to subscription levels, determines (239) bid price thresholds (171, 173, and 175) by which to divide the pay for performance listings (e.g., pay for call listings (125)) into groups (e.g., 162, 164, 166, and 168) corresponding to the groups (e.g., 161, 163, 165, and 167) of the subscription listings (121), and interleaves (241) the groups (e.g., 161, 163, 165, and 167) of subscription listings (121) and the groups (e.g., 162, 164, 166, and 168) of pay for performance listings (e.g., pay for call listings (125)), by starting with a group (161) of the subscripting listings (121) to unconditionally place the group (161) of the subscription listings (121) above the groups (e.g., 162, 164, 166, and 168) of the pay for performance listings (e.g., pay per call listings (125)).

In one embodiment, the sorter (117) sorts the groups of the subscription listings according to subscription fee by considering subscription levels and subscription options. The communication server (104) presents (243) listings (e.g., 121 and 125) in an order according to the interleaved groups (e.g., 161-168).

In one embodiment, the sorter (117) determines average performance of the groups (161, 163, 165, and 167) of the subscription listings (121) based on the statistics (115) and determines the plurality of thresholds (171, 173, and 175) based on the average performance of the groups (161, 163, 165, and 167) of the subscription listings (121).

In one embodiment, the search engine (113) determines a business category of the subscription listings (121) and the pay for performance listings, such as the pay per call listings (125). The sorter (117) determines the plurality of thresholds (171, 173, and 175) based on the average performance of subscription listings (121) of a plurality subscription levels in the business category.

In one embodiment, the groups (161, 163, 165 and 167) of subscription listings (121) include a first group (161) identified based on subscription fee (129); and the sorter (117) unconditionally provides the first group (161) of the subscription listings (121) with priority higher than the pay for performance listings, such as pay per call listings (125), in the ordered list.

In one embodiment, the connection server (109) tracks the number of telephone calls connected via presentations of a group (e.g., 161) of the subscription listings (121). The sorter (117) determines an average price per telephone call connected via presentation of the group (e.g., 161) of the subscription listings (121) and determines one of the plurality of the thresholds (e.g., 171) based on the average price.

In some embodiments, the pay for performance listings are charged according to the bid prices in response to forwarding a web request as a result of a presentation of a listing.

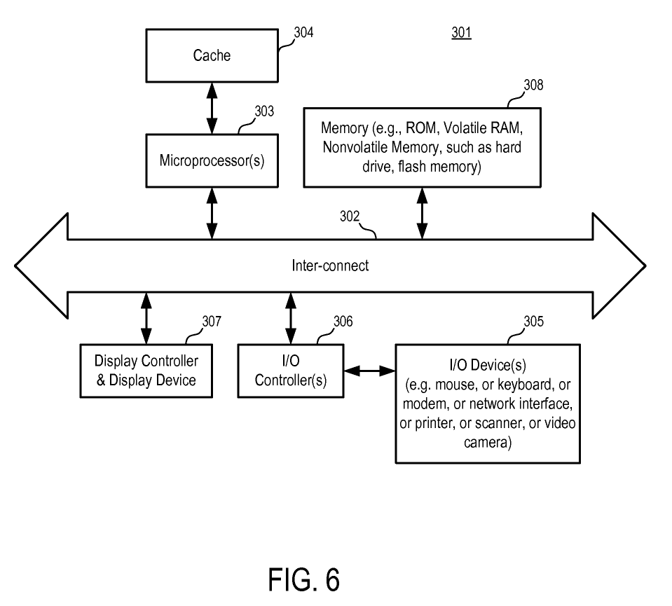

FIG. 6 illustrates a data processing system which can be used in various embodiments. While FIG. 6 illustrates various components of a computer system, it is not intended to represent any particular architecture or manner of interconnecting the components. Some embodiments may use other systems that have fewer or more components than those shown in FIG. 6.

In one embodiment, a server data processing system illustrated in FIG. 6 implements at least one of the components shown in FIG. 1, such as the web server(s) (107), the location detector (111), the search engine (113), the sorter (117), the connection server (109), and/or the storage facility (123), etc. In some embodiments, one or more of the components shown in FIG. 1, such as the web server(s) (107), the location detector (111), the search engine (113), the sorter (117), the connection server (109), and/or the storage facility (123), etc. may include the service of a peer to peer network of a plurality of data processing systems as illustrated in FIG. 6, or a network of distributed computing systems. In some embodiments, a server data processing system as illustrated in FIG. 6 may include a peer to peer network, or a distributed computing system.

In one embodiment, a terminal (e.g., 103 or 147) is a data processing system as illustrated in FIG. 6.

In FIG. 6, the data processing system (301) includes an inter-connect (302) (e.g., bus and system core logic), which interconnects a microprocessor(s) (303) and memory (308). The microprocessor (303) is coupled to cache memory (304) in the example of FIG. 6.

The inter-connect (302) interconnects the microprocessor(s) (303) and the memory (308) together and also interconnects them to a display controller and display device (307) and to peripheral devices such as input/output (I/O) devices (305) through an input/output controller(s) (306). Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect (302) may include one or more buses connected to one another through various bridges, controllers and/or adapters. In one embodiment the I/O controller (306) includes a USB (Universal Serial Bus) adapter for controlling USB peripherals, and/or an IEEE-1394 bus adapter for controlling IEEE-1394 peripherals.

The memory (308) may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs”. The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method implemented on a data processing system, the method comprising:
identifying a plurality of subscription listings and a plurality of pay for performance listings;
comparing values of the pay for performance listings with values of the subscription listings, wherein the values of the subscription listings are based at least in part on renewal of subscriptions; and
sorting the plurality of subscription listings and the plurality of pay for performance listings into one ordered list based on the comparing of the values of the pay for performance listings with the values of the subscription listings.

2. The method of claim 1, further comprising:
dividing the subscription listings into a plurality of groups;
dividing the pay for performance listings into a plurality of groups based on a plurality of thresholds corresponding to the groups of subscription listings;
wherein the sorting comprises interleaving the groups of subscription listings and the groups of pay for performance listings.

3. The method of claim 2, further comprising:
determining average performance of the groups of the subscription listings; and
determining the plurality of thresholds based on the average performance of the groups of the subscription listings.

4. The method of claim 2, further comprising:
determining a business category of the subscription listings and the pay for performance listings; and
determining the plurality of thresholds based on average performance of subscription listings of a plurality of subscription levels in the business category.

5. The method of claim 2, wherein the groups of subscription listings include a first group identified based on subscription fee; and the first group of the subscription listings is unconditionally provided with priority higher than the pay for performance listings in the ordered list.

6. The method of claim 2, wherein the interleaving comprises:
sorting the groups of the subscription listings according to subscription fee;
sorting the groups of the pay for performance listings according to bid price; and
unconditionally placing a group of the subscription listings above the groups of the pay for performance listings.

7. The method of claim 2, wherein each of the groups of the pay for performance listings is sorted according to bid prices for performance.

8. The method of claim 7, wherein the pay for performance listings are charged according to the bid prices in response to connecting a telephone call as a result of a presentation of a listing.

9. The method of claim 8, further comprising:
determining a number of telephone calls connected via presentations of a group of the subscription listings;
determining an average price per telephone call connected via presentation of the group of the subscription listings; and
determining one of the plurality of the thresholds based on the average price.

10. The method of claim 7, wherein the pay for performance listings are charged according to the bid prices in response to forwarding a web request as a result of a presentation of a listing.

11. The method of claim 7, wherein the values of the pay for performance listings are based at least in part on the bid prices and a conversion rate between presentation and performance.

12. The method of claim 2, wherein each of the groups of pay for performance listings is sorted according to prices to charge customers of the pay for performance listings; and the values of the pay for performance listings are based at least in part on fees determined based on the prices.

13. The method of claim 1, further comprising:
appending free listings after the ordered list.

14. The method of claim 13, wherein the subscription listings, the pay for performance listings and the free listings provide telephonic contact of businesses of services or products.

15. A machine readable media storing instructions, the instructions causing a data processing system to perform a method, the method comprising:
receiving a search request for listings of services or products;
responsive to the search request, identifying a plurality of listings, including subscription listings and pay for performance listings, wherein the subscription listings offer periodic subscription fees for priority in search results and the pay for performance listings offer fees to be charged in response to a predetermined event that is a result of presentation of the pay for performance listings; and
sorting the plurality of listings, including the subscription listings and the pay for performance listings, into an ordered list to increase revenue for a time period longer than a subscription period of the subscription listings.

16. The media of claim 15, wherein the predetermined event comprises connecting a telephone call to a telephonic contact associated with a pay for performance listing;
and the method further comprises:
tracking telephone calls to telephonic contacts associated with the subscription listings;
based on the tracked telephone calls, converting the subscription fees to equivalent fees charged in response to a telephone call; and
wherein the sorting comprises sorting using the equivalent fees.

17. The media of claim 16, wherein the equivalent fees are based on business categories of the subscription listings and subscription levels of the subscription listings.

18. The media of claim 15, wherein the search request indicates a geographic area; and
the identifying of the plurality of listings comprises:
identifying no more than a predetermined number of first pay for performance listings for inclusion in the plurality of listings, the first pay for performance listings providing services or products in the geographic area and in more than a predetermined number of states; and
identifying second pay for performance listings for inclusion in the plurality of listings, the second pay for performance listings providing services or products in the geographic area and in no more than the predetermined number of states.

19. The media of claim 18, wherein the first pay for performance listings are provided higher priority than the second pay for performance listings in the ordered list.

20. A data processing system, comprising:
means for identifying a plurality of subscription listings and a plurality of pay for performance listings;
means for comparing values of the pay for performance listings with values of the subscription listings, wherein the values of the subscription listings are based at least in part on renewal of subscriptions; and
means for sorting the plurality of subscription listings and the plurality of pay for performance listings into one ordered list based on the comparing of the values of the pay for performance listings with the values of the subscription listings.
